(19) United States
(12) Patent Application Publication
(10) Pub. No.: US 2009/0190267 A1
(43) Pub. Date: Jul. 30, 2009

(54) RuTi AS A SEED LAYER IN PERPENDICULAR RECORDING MEDIA

(76) Inventors: Xiaoping Bian, Saratoga, CA (US); Mary Minardi, Santa Cruz, CA (US); Kai Tang, San Jose, CA (US)

Correspondence Address: Kunzler & McKenzie, 8 EAST BROADWAY, SUITE 600, SALT LAKE CITY, UT, 84111, US

(21) Appl. No.: 12/020,235

(22) Filed: Jan. 25, 2008

(51) Int. Cl. G11B 5/33

(52) U.S. Cl. 360/313

(57) ABSTRACT

A method for reducing thin film media layer thickness while maintaining adequate magnetic recording performance includes providing a substrate comprising a rigid support structure, depositing a soft underlayer on top of the substrate, depositing an interlayer on top of the soft underlayer and depositing a exchange break layer on top of the interlayer, wherein the exchange break layer comprises a flash layer of RuTi and a seed layer of Ru. The flash layer is deposited in place of a pure Ru layer, thereby reducing the amount of Ru deposited as well as decreasing the thickness of the overall intermediate layer. The magnetic performance of the media is maintained with the substitution of a RuTi flash layer for a pure Ru layer.

### BACKGROUND OF THE INVENTION

1. Field of the Invention

This invention relates to perpendicular magnetic recording media, including continuous and patterned recording media, and more particularly to apparatus and methods for reducing the thickness and cost of an exchange break layer of perpendicular magnetic recording media.

2. Description of the Related Art

Hard-disk drives provide data storage for data processing systems in computers and servers, and are becoming increasingly pervasive in media players, digital recorders, and other personal devices. Advances in hard-disk drive technology have made it possible for a user to store an immense amount of digital information on an increasingly small disk, and to selectively retrieve and alter portions of such information almost instantaneously. Particularly, recent developments have simplified hard-disk drive manufacture while yielding increased track densities, thus promoting increased data storage capabilities at reduced costs.

In a hard-disk drive, rotating high precision aluminum or glass disks are coated on both sides with a special thin film media designed to store information in the form of magnetic patterns. Electromagnetic read/write heads suspended or floating only fractions of micro inches above the disk are used to either record information onto the thin film media, or read information from it.

A read/write head may write information to the disk by creating an electromagnetic field to orient a cluster of magnetic grains, known as a bit, in one direction or the other. In longitudinal magnetic recording media applications, a magnetic recording layer has a magnetic c-axis (or easy axis) parallel to the disk plane. As the Hard-Drive industry is transitioning to perpendicular recording technology, adjustments are being made to adapt the disk media so that the magnetic c-axis of the Cobalt alloy grows perpendicular to the disk plane. Hexagonal Close Packed (HCP) cobalt alloys are typically used as a magnetic recording layer for perpendicular recording. Most media manufacturers now rely on a Cobalt alloy with the incorporation of an oxide segregant to promote the formation of small and uniform grains.

To read information, magnetic patterns detected by the read/write head are converted into a series of pulses which are sent to the logic circuits to be converted to binary data and processed by the rest of the system. To write information, a write element located on the read/write head generates a magnetic write field that travels vertically through the magnetic recording layer and returns to the write element through a soft underlayer. In this manner, the write element magnetizes vertical regions, or bits, in the magnetic recording layer. Because of the easy axis orientation, each of these bits has a magnetization that points in a direction substantially perpendicular to the media surface. To increase the capacity of disk drives, manufacturers are continually striving to reduce the size of bits and the grains that comprise the bits.

The ability of individual magnetic grains to be magnetized in one direction or the other, however, poses problems where grains are extremely small. The superparamagnetic effect results when the product of a grain's volume (V) and its anisotropy energy (Kᵤ) fall below a certain value such that the magnetization of that grain may flip spontaneously due to thermal excitations. Where this occurs, data stored on the disk is corrupted. Thus, while it is desirable to make smaller grains to support higher density recording with less noise, grain miniaturization is inherently limited by the superparamagnetic effect. To maintain thermal stability of the magnetic grains, material with high Kᵤ may be used for the magnetic layer. However, material with a high Kᵤ requires a stronger magnetic field to reverse the magnetic moment. Thus, the ability of the write head to write on magnetic material may be reduced where the magnetic layer has a high Kᵤ value.

The perpendicular magnetic recording medium is generally formed with a substrate, a soft magnetic underlayer (SUL), an interlayer, an exchange break layer, a perpendicular magnetic recording layer, and a protective layer for protecting the surface of the perpendicular magnetic recording layer. The exchange break layer and the interlayer comprise a plurality of Ruthenium layers which serve to control the size and orientation of the magnetic crystal grains in the magnetic recording layer. The exchange break layer and the interlayer also serve to magnetically de-couple the SUL and the perpendicular magnetic recording layer. Ruthenium is a rare material and therefore adds substantially to the overall cost involved with creating the perpendicular recording medium.

Accordingly, a need exists for a practical, attainable apparatus, system, and method for reducing thin film media layer thickness. Beneficially, such an apparatus, system and method would reduce the amount of Ruthenium used in the layers on a thin film media. Such apparatuses, systems and methods are disclosed and claimed herein.

### SUMMARY OF THE INVENTION

The present invention has been developed in response to the present state of the art, and in particular, in response to the problems and needs in the art that have not yet been fully solved by currently available apparatus, systems and methods. Accordingly, the present invention has been developed to provide apparatus, system and methods for reducing thin film media layer thickness while simultaneously reducing the use of Ruthenium in the layers on a thin film media.

In one embodiment in accordance with the invention, a recording medium for perpendicular recording applications includes a soft magnetic underlayer deposited on a nonmagnetic substrate and a perpendicular magnetic recording layer deposited below an overcoat layer. A flash layer is deposited between the soft magnetic underlayer and the perpendicular magnetic recording layer. The perpendicular magnetic recording layer has an axis of magnetic anisotropy substantially perpendicular to the surface thereof. The flash layer comprises a RuTi alloy.

In certain embodiments, the concentration of Ti in the RuTi alloy is in the range of about 5 to about 20 atomic percent. In select embodiments, the concentration of Ti is about 10 atomic percent. In certain embodiments the thickness of the flash layer is in the range of about 5 to about 20 angstroms.

In another embodiment in accordance with the invention, a recording medium for perpendicular recording applications includes a substrate comprising a rigid support structure for depositing a plurality of layers thereon, an overcoat layer comprising a protective coating, a soft magnetic underlayer disposed between the overcoat layer and the substrate, an interlayer deposited on the soft magnetic underlayer, an exchange break layer disposed on the interlayer, and a perpendicular magnetic recording layer disposed between the exchange break layer and the overcoat layer. The soft underlayer comprises a cobalt containing alloy and the exchange break layer comprises a flash layer and a seed layer. The flash layer comprises a RuTi alloy wherein the concentration of Ti is in the range of about 5 to about 20 atomic percent. The seed layer comprises Ru. The perpendicular magnetic recording layer has a coercivity and an axis of magnetic anisotropy substantially perpendicular to the surface thereof.

In certain embodiments the crystal structure of the flash layer comprises a hexagonal-close-packed structure that orients the c-axis of the grains of the perpendicular magnetic recording layer perpendicular to the flash layer.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a top view of a hard-disk drive;

FIG. 2 is a cross-section view of the layers of a perpendicular recording media in accordance with one embodiment of the present invention;

FIG. 3 is a cross-section view of the layers of a perpendicular recording media showing a read/write head disposed above the media in accordance with one embodiment of the present invention;

FIGS. 4A-4D are cross-section views illustrating several embodiments of the interlayer in accordance with the present invention;

FIGS. 5A and 5B are cross-section views illustrating two embodiments of the exchange break layer in accordance with the present invention;

FIG. 6 is a flowchart showing a method for fabricating a perpendicular recording medium according to one embodiment in accordance with the present invention;

FIG. 7 is a flowchart showing a method for fabricating a perpendicular recording medium according to one embodiment in accordance with the present invention;

FIG. 8 is a flowchart showing a method for fabricating a perpendicular recording medium according to one embodiment in accordance with the present invention;

FIG. 9 illustrates a comparison of rocking angles (c-axis dispersion angle) for an exchange break layer without a RuTi flash layer versus an exchange break layer with a RuTi flash layer according to one embodiment of the current invention;

FIG. 10 is a table illustrating performance values for media with a RuTi flash layer versus media without a RuTi flash layer according to one embodiment of the current invention;

FIG. 11A is a graph illustrating a change in coercivity as a function of a RuTi flash layer thickness in accordance with one embodiment of the current invention;

FIG. 11B is a graph illustrating soft error rate of magnetic performance as a function of a RuTi flash layer thickness in accordance with one embodiment of the current invention; and

FIG. 12 is a graph illustrating the change in coercivity as a function of layer thickness according to one embodiment of the current invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are disclosed to provide a thorough understanding of embodiments of the present invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

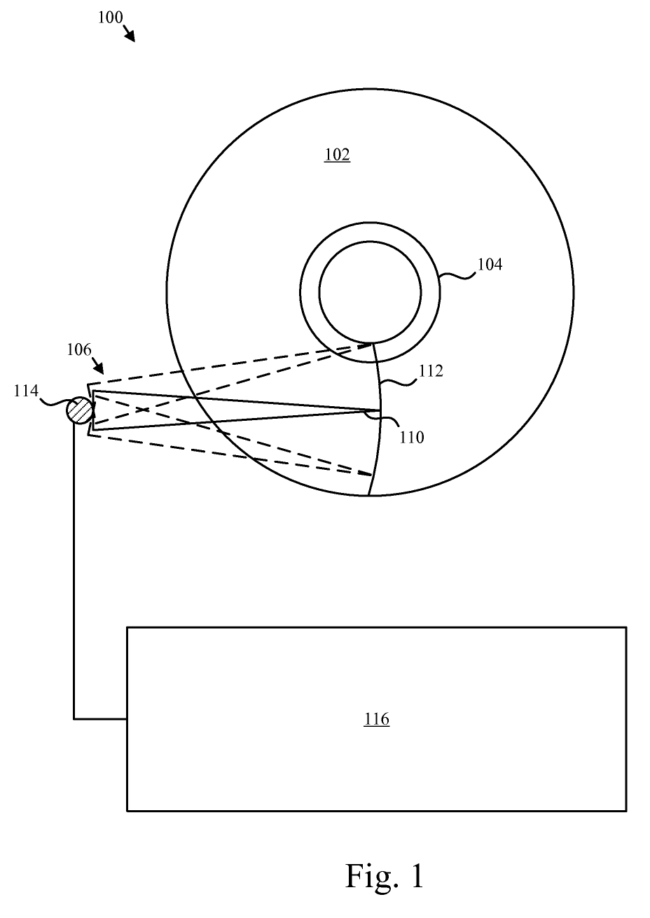

Referring now to FIG. 1, a diagram of a conventional hard-disk drive assembly 100 is shown. A hard-disk drive assembly 100 generally comprises a plurality of hard disks comprising a perpendicular magnetic recording media 102, rotated at high speeds by a spindle motor (not shown) during operation. The perpendicular magnetic recording media 102 will be more fully described herein. Concentric data tracks 104 formed on either or both disk surfaces receive and store magnetic information.

A read/write head 110 may be moved across the disk surface by an actuator assembly 106, allowing the head 110 to read or write magnetic data to a particular track 104. The actuator assembly 106 may pivot on a pivot 114. The actuator assembly 106 may form part of a closed loop feedback system, known as servo control, which dynamically positions the read/write head 110 to compensate for thermal expansion of the perpendicular magnetic recording media 102 as well as vibrations and other disturbances. Also involved in the servo control system is a complex computational algorithm executed by a microprocessor, digital signal processor, or analog signal processor 116 that receives data address information from an associated computer, converts it to a location on the perpendicular magnetic recording media 102, and moves the read/write head 110 accordingly.

Specifically, read/write heads 110 periodically reference servo patterns recorded on the disk to ensure accurate head 110 positioning. Servo patterns may be used to ensure a read/write head 110 follows a particular track accurately, and to control and monitor transition of the head 110 from one track 104 to another. Upon referencing a servo pattern, the read/write head 110 obtains head position information that enables the control circuitry 116 to subsequently re-align the head 110 to correct any detected error.

Servo patterns may be contained in engineered servo sectors 112 embedded within a plurality of data tracks 104 to allow frequent sampling of the servo patterns for optimum disk drive performance. In a typical perpendicular magnetic recording media 102, embedded servo sectors 112 extend substantially radially from the perpendicular magnetic recording media 102 center, like spokes from the center of a wheel. Unlike spokes however, servo sectors 112 form a subtly arc-shaped path calibrated to substantially match the range of motion of the read/write head 110.

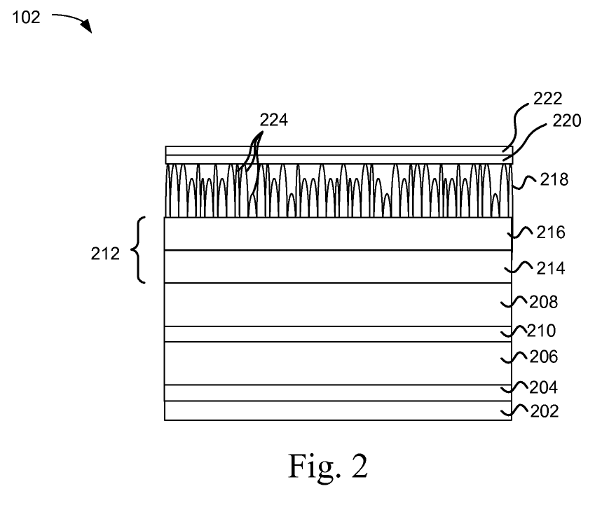

FIG. 2 is a cross-sectional view of one possible embodiment of the perpendicular magnetic recording media 102. The layers shown in FIG. 2 may be deposited on a substrate 202 or on an adhesion layer 204 previously deposited on the substrate 202. The layers may include a plurality of soft underlayers 206 and 208 separated by an antiferromagnetic coupling layer 210, an intermediate layer 212 comprising an interlayer 214 and an exchange break layer 216, a perpendicular magnetic recording layer 218, a capping layer 220 and an overcoat 222. The perpendicular magnetic recording media 102 may include other layers not shown in FIG. 2. Similarly, one skilled in the art will recognize that some of the layers illustrated in FIG. 2 may be omitted in certain embodiments.

The platter or substrate 202 may comprise an AlMg or glass platter which provides a rigid support structure upon which the recording media is deposited. In certain embodiments ion beam deposition or magnetron sputtering may be utilized to deposit the various layers comprising the perpendicular magnetic recording media 102.

In one embodiment, the first layer deposited on substrate 202 is an adhesion layer 204. The adhesion layer 204 may comprise an AlTi layer to aid in the adhesion of subsequent layers. In certain embodiments the adhesion layer 204 may be omitted and a soft underlayer 206 may be deposited directly on the substrate 202.

The material comprising the soft underlayers 206 and 208 is a soft, magnetic, cobalt containing alloy located under the interlayer 214. In certain embodiments the material comprising the soft underlayers 206 and 208 may be CoFeTaZr.

An antiferromagnetic coupling layer 210 may be disposed between the soft underlayers 206 and 208 to couple the two soft underlayers 206 and 208. The antiferromagnetic coupling layer 210 may be used to reduce magnetic signals originating from the soft underlayers 206 and 208 where such signals are undesirable in the perpendicular magnetic recording media 102.

The magnetic recording medium 102 may include a magnetic recording layer 218, to store data. The magnetic recording layer 218 may comprise a plurality of magnetic grains 224 each having a magnetic easy axis substantially perpendicular to the media surface, thereby allowing the grains 224 to be vertically magnetized. The magnetic grains 224 may comprise a magnetic material such as CoPt or CoPtCr. To maintain a highly segregated magnetic layer 218, one or more segregants may be added to the magnetic material.

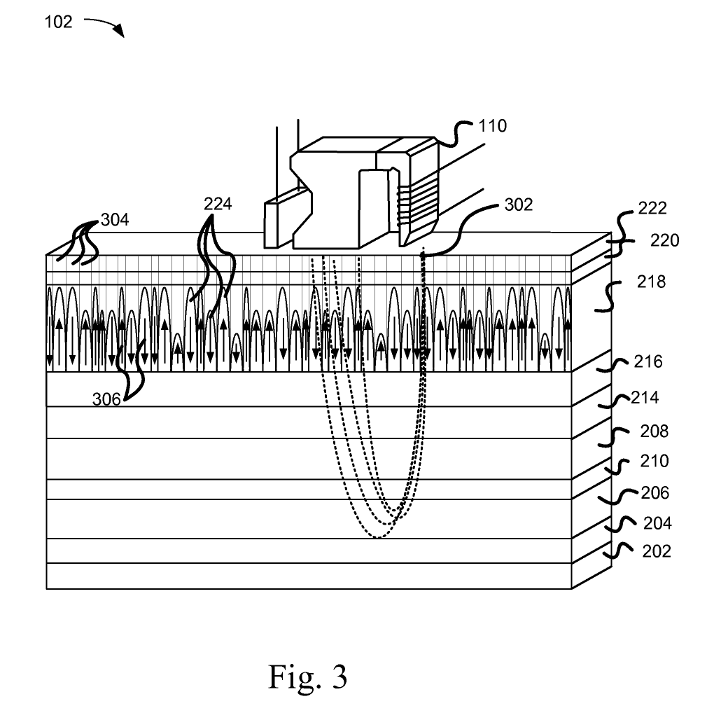

Referring now to FIG. 3, when writing, the write head 110 generates a magnetic write field 302 that travels vertically through the magnetic recording layer 218 and returns to the write head 110 through the soft underlayer 206 and 208. In this manner, the write head 110 magnetizes vertical regions 304, or bits 304, in the magnetic recording layer 218. Because of the easy axis orientation, each of these bits 304 has a magnetization 306 that points in a direction substantially perpendicular to the media surface.

Because of the ability to utilize soft underlayers 206 and 208 in the perpendicular geometry, write fields generated by the perpendicular write head 110 may be substantially larger than conventional longitudinal recording write fields. This allows use of media 102 having a higher coercivity (Hc) and anisotropy energy (Ku), which is more thermally stable. Furthermore, unlike longitudinal recording, where the magnetic fields between two adjacent bits have a destabilizing effect, the magnetic fields of magnetization 306 of bits in perpendicular recording media 102 stabilize each other, enhancing the overall stability of perpendicular magnetic recording media even further. This allows for closer bit packing.

Capping layer 220 is deposited on top of the perpendicular magnetic recording layer 218 which may comprise a Co alloy. Capping layer 220 serves to improve writeability of the media and to planarize the media to create a smooth surface upon which overcoat layer 222 is disposed. The Overcoat layer 222 may comprise a plurality of carbon layers to protect the perpendicular magnetic recording layer 218 and capping layer 220 against damage.

An intermediate layer 212 may comprise a nonmagnetic layer disposed between the soft underlayer 208 and the perpendicular magnetic recording layer 218. The intermediate layer 212 may comprise an interlayer 214 and an exchange break layer 216. The intermediate layer 212 may serve to prevent the soft underlayer 208 from magnetically coupling with the perpendicular magnetic recording layer 218. The intermediate layer 212 may also comprise a hexagonal-close-packed (HCP) crystalline structure to orient the magnetic grains 224 on the perpendicular magnetic recording layer 218 such that the magnetic c-axis or easy axis is parallel to the disk plane.

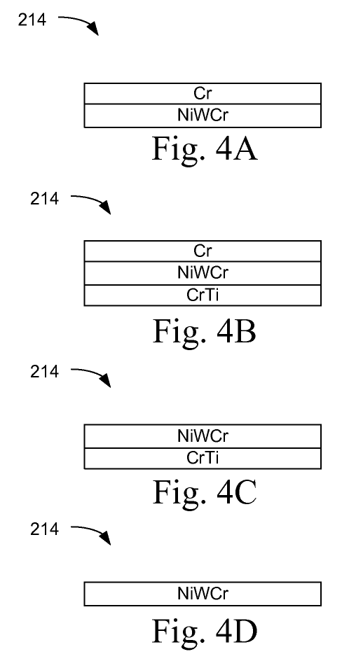

Turning now to FIG. 4A through 4D, the interlayer 214 may comprise a plurality of Cr containing layers. The material comprising the interlayer 214 may be a material with a HCP crystalline structure to act as a foundation to help align the magnetic grains 224 of the magnetic layer 218 perpendicular to the disk surface. In the embodiment illustrated in FIG. 4A a Cr layer may be deposited on a NiWCr layer. In another embodiment, illustrated in FIG. 4B the NiWCr layer may be deposited on a CrTi layer. In other embodiments, the pure Cr layer may be omitted as illustrated in FIG. 4C. In another embodiment, illustrated in FIG. 4D, NiWCr may be the only layer comprising the interlayer 214. In another embodiment, not illustrated, the interlayer may be omitted and the exchange break layer 216 may be deposited directly on the soft underlayer 208. Use of a Cr containing interlayer 214 permits a thinner Ru containing exchange break layer 216.

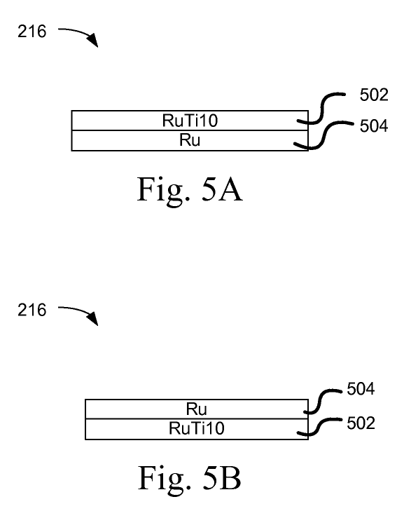

FIG. 5A and FIG. 5B illustrate embodiments of the exchange break layer 216. A flash layer 502 comprising a RuTi alloy may be deposited on a seed layer 504. In certain embodiments the concentration of Ti in the flash layer 502 may be between about 5 to about 20 atomic percent. In one embodiment the concentration of Ti in the flash layer 502 may be about 10 atomic percent. The flash layer 502 may be about 5 angstroms to about 20 angstroms thick. The seed layer 504 may comprise pure Ru to orient the magnetic grains 224 of the perpendicular magnetic recording layer 218. In the embodiment illustrated in FIG. 5B the seed layer 504 may be deposited on the flash layer 502.

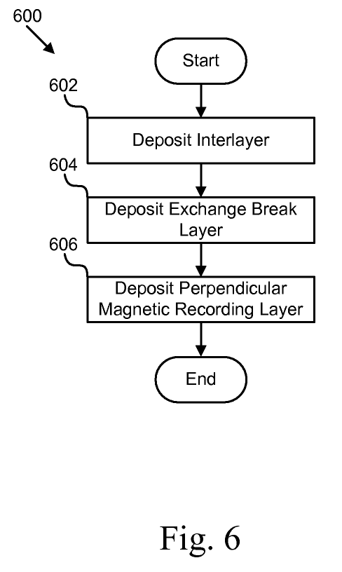

FIG. 6 is a flow chart diagram depicting one embodiment of a method 600 for fabricating perpendicular recording medium 102 in accordance with the present invention. As depicted, the material for interlayer 214 may be deposited 602 first. The interlayer 214 may be deposited on a substrate 202 or on other layers as previously described. The interlayer may comprise pure Cr, a Cr containing alloy or layers of both pure Cr and Cr containing alloys. In step 604, material for an exchange break layer 216 may be deposited on the interlayer 214. The material for the exchange break layer may comprise a RuTi containing alloy. In step 606, material for a perpendicular magnetic recording layer 218 may be deposited on the exchange break layer 216. The material for the perpendicular magnetic recording layer 218 may comprise CoPtCr—SiOx or another similar material. There may be additional layers of material deposited than those described in method 600.

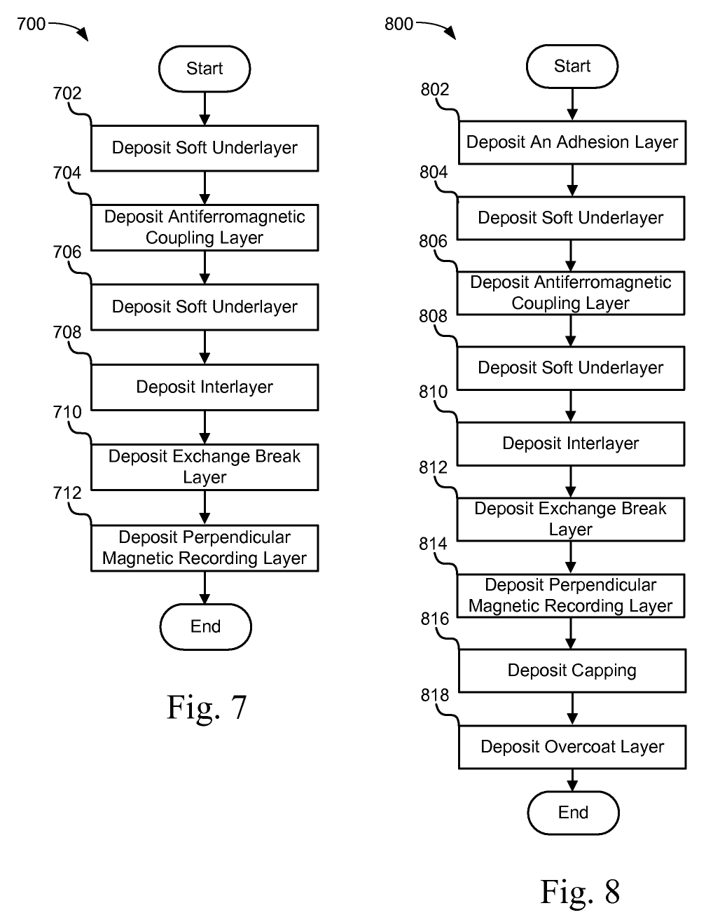

FIG. 7 is a flow chart of another possible method 700 of fabricating perpendicular magnetic recording medium 102. In step 702, material for a soft magnetic underlayer 206 is deposited on a substrate 202. In step 704, material for an antiferromagnetic coupling layer 210 is deposited on the soft magnetic underlayer 206. In step 706, material for another soft magnetic underlayer 208 is deposited on the antiferromagnetic coupling layer 210. In step 708, material for an interlayer 214 is deposited on the soft magnetic underlayer 208. In step 710, material for an exchange break layer 216 is deposited on the interlayer 214. In step 712, material for a perpendicular magnetic recording layer 218 is deposited on the exchange break layer 216. There may be other layers of material deposited than those described in method 700.

FIG. 8 is a flow chart of another possible method 800 of fabricating perpendicular magnetic recording medium 102. In step 802, material for an adhesion layer 204 is deposited on a substrate 202. In step 804, material for a first soft magnetic underlayer 206 is deposited on adhesion layer 204. In step 806, material for an antiferromagnetic coupling layer 210 is deposited on the first soft magnetic underlayer layer 206. In step 808, material for a second soft magnetic underlayer 208 is deposited on the antiferromagnetic coupling layer 210. In step 810, material for an interlayer 214 is deposited on the second soft magnetic underlayer 208. In step 812, material for an exchange break layer 216 is deposited on the interlayer 214. In step 814, material for a perpendicular magnetic recording layer 218 is deposited on the exchange break layer 216. In step 816, material for a capping layer 220 is deposited on the perpendicular magnetic recording layer 218. In step 818, overcoat layer 222 is deposited on the capping layer 220. There may be other layers of material deposited than those described in method 800.

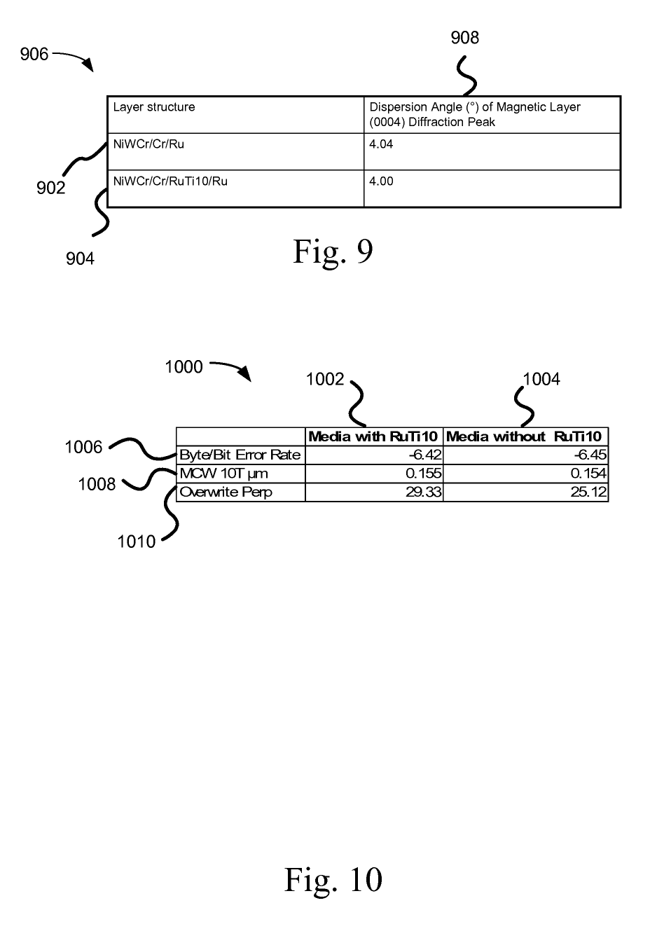

FIG. 9 illustrates a comparison of rocking angles (c-axis dispersion angle) for a first exchange break layer 902 without a RuTi flash layer 502 versus a second exchange break layer 902 with a RuTi flash layer 502 according to one embodiment of the current invention. An interlayer 902 comprising a NiWCr layer, a Cr layer and a Ru layer was compared with an interlayer 904 comprising NiWCr layer, a Cr layer, a RuTi 10 layer and a Ru layer. The resulting data is illustrated a table 906 in FIG. 9. As can be seen in FIG. 9, when a flash layer 502 containing RuTi is incorporated into the exchange break layer 904, the rocking angle 908 of the perpendicular magnetic recording layer 218 is not increased. Thus, there is no deterioration of the crystallographic texture with the addition of a RuTi flash layer 502.

FIG. 10 is a table 1000 illustrating performance values for media with a RuTi flash layer 502 in the second column 1002 and media without a RuTi flash layer 504 in the third column 1004 according to one embodiment of the current invention. The Byte/Bit Error Rate 1006 for media with a RuTi flash layer 502 is substantially the same as the Byte/Bit Error Rate 1006 for media without a RuTi flash layer 502. Similarly, the magnetic core width 1008 may remain substantially the same for media with a RuTi flash layer 502 as the magnetic core width 1008 for media without a RuTi flash layer 502. Thus, according to one embodiment of the current invention, the addition of a RuTi flash layer 502 may result in media with substantially the same performance characteristics as media without a RuTi flash layer. Further, the writeability 1010 for media with a RuTi flash layer 502 is greater than for media without a RuTi flash layer 502. As a result, a magnetic material with a higher magnetic anisotropy (Kᵤ) may be used for magnetic recording layer 218.

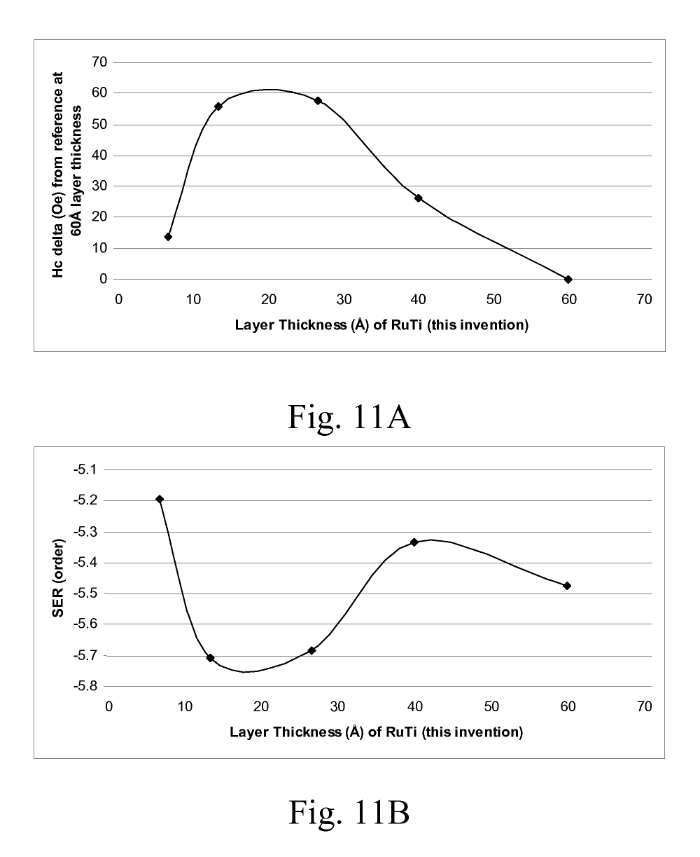

With reference to FIG. 11A and FIG. 11B, an optimum RuTi flash layer 502 thickness may provide the highest magnetic coercive field required to reverse the magnetization of magnetic grains 224 as illustrated in FIG. 11A. In one embodiment, the optimum thickness of the flash layer 502 may be in the range of about 5 angstroms to about 20 angstroms to provide the highest magnetic coercive field. Similarly, the optimum RuTi flash layer 503 thickness may provide the lowest soft error rate as illustrated in FIG. 11B. In certain embodiments, the optimum thickness of the flash layer 502 to provide the lowest soft error rate may be in the range of about 5 angstroms to about 20 angstroms. In one embodiment the optimum thickness of the RuTi flash layer 503 may be the same to produce both the highest coercivity level as wells as the lowest soft error rate.

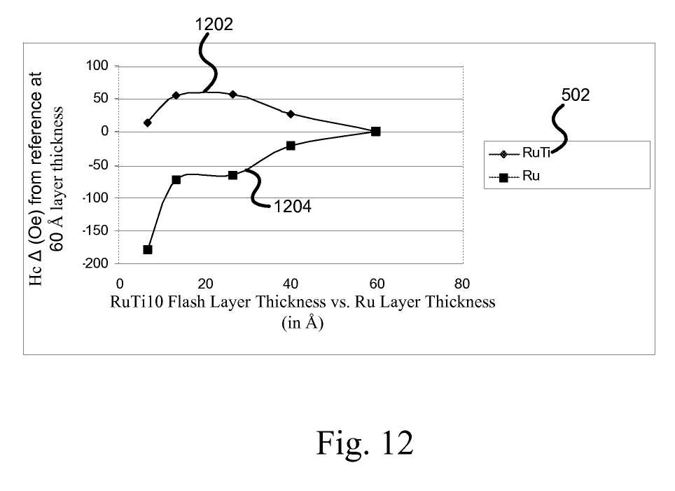

FIG. 12 is a graph illustrating the change in coercivity as a function of layer thickness according to one embodiment of the current invention. As can be seen, a RuTi flash layer 502 may provide an optimum 1202 intermediate layer 212 thickness which is much smaller than media 102 without a RuTi flash layer 502 as illustrated by line 1204. In certain embodiments the optimum 1202 thickness of the RuTi flash layer 502 is about 5 angstroms to about 20 angstroms.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A perpendicular magnetic recording medium, comprising:
a soft magnetic underlayer deposited on a substrate;
a perpendicular magnetic recording layer deposited below an overcoat layer, the perpendicular magnetic recording layer having an axis of magnetic anisotropy substantially perpendicular to the surface thereof;
a flash layer deposited between the soft magnetic underlayer and the perpendicular magnetic recording layer, the flash layer comprising an alloy including RuTi.

2. The perpendicular magnetic recording medium of claim 1, wherein the concentration of Ti is in the range of about 5 to about 20 atomic percent.

3. The perpendicular magnetic recording medium of claim 1, wherein the concentration of Ti is about 10 atomic percent.

4. The perpendicular magnetic recording medium of claim 1, wherein the thickness of the flash layer is in the range of about 5 to about 20 angstroms.

5. The recording medium of claim 1, wherein the crystal structure of the flash layer comprises a hexagonal-close-packed structure that orients the c-axis of the grains of the perpendicular magnetic recording layer perpendicular to the flash layer.

6. The recording medium of claim 1 further comprising an interlayer and a seed layer, the flash layer and the seed layer disposed between the interlayer and the perpendicular magnetic recording layer.

7. A recording medium for perpendicular recording applications, the recording medium comprising:
a substrate comprising a rigid support structure for depositing a plurality of layers thereon;
an overcoat layer comprising a protective coating;
a soft magnetic underlayer disposed between the overcoat layer and the substrate, the soft underlayer;
an interlayer deposited on the soft magnetic underlayer;
an exchange break layer disposed on the interlayer, the exchange break layer comprising a flash layer and a seed layer, the flash layer comprising a RuTi alloy wherein the concentration of Ti is in the range of about 5 to about 20 atomic percent and the seed layer comprises Ru; and
a perpendicular magnetic recording layer disposed between the exchange break layer and the overcoat layer, the perpendicular magnetic recording layer having an axis of magnetic anisotropy substantially perpendicular to the surface thereof.

8. The perpendicular magnetic recording medium of claim 7, wherein the concentration of Ti is about 10 atomic percent.

9. The recording medium of claim 7, wherein the thickness of the flash layer is in the range of about 5 to about 20 angstroms.

10. The recording medium of claim 7, wherein the crystal structure of the flash layer and the seed layer comprise a hexagonal-close-packed structure that orients a c-axis of the grains of the perpendicular magnetic recording layer perpendicular to the flash layer.

11. The recording medium of claim 7, wherein the flash layer and the seed layer are disposed between the interlayer and the perpendicular magnetic recording layer.

12. A recording device for perpendicular recording applications, the recording device comprising:
a recording head for reading magnetic signals from, and writing magnetic signals to, a recording medium; and
a recording medium configured for perpendicular recording, the recording medium comprising:
a substrate comprising a rigid support structure for depositing a plurality of layers thereon;
an overcoat layer comprising a protective coating;
a soft magnetic underlayer disposed between the overcoat layer and the substrate;
an interlayer disposed between the soft magnetic underlayer and a exchange break layer;
the exchange break layer comprising a flash layer and a seed layer, the flash layer comprising a RuTi alloy wherein the thickness of the flash layer is in the range of about 5 angstroms to about 20 angstroms and the concentration of Ti is in the range of about 5 to about 20 atomic percent; and
a perpendicular magnetic recording layer disposed between the exchange break layer and the overcoat layer, the perpendicular magnetic recording layer having a coercivity and an axis of magnetic anisotropy substantially perpendicular to the surface thereof;

13. The recording device for perpendicular recording applications of claim 12, wherein the crystal structure of the exchange break layer comprises a hexagonal-close-packed structure that orients a c-axis of the grains of the perpendicular magnetic recording layer perpendicular to the flash layer.

14. The recording device for perpendicular recording applications of claim 12, wherein the flash layer and the seed layer are disposed between the interlayer and the perpendicular magnetic recording layer.

15. A recording medium for perpendicular recording applications, the recording medium comprising:
a substrate comprising a rigid support structure for depositing a plurality of layers thereon;
an overcoat layer comprising a protective coating;
a soft magnetic underlayer disposed between the overcoat layer and the substrate, the soft underlayer comprising a cobalt containing alloy;
an interlayer deposited on the soft magnetic underlayer, the interlayer comprising a CrTi alloy;
an exchange break layer disposed on the interlayer, the exchange break layer comprising a flash layer and a seed layer, the flash layer comprising a RuTi alloy wherein the concentration of Ti is in the range of about 5 to about 20 atomic percent and the seed layer comprises Ru; and
a perpendicular magnetic recording layer disposed between the exchange break layer and the overcoat layer, the perpendicular magnetic recording layer having an axis of magnetic anisotropy substantially perpendicular to the surface thereof.

16. The recording medium of claim 15, wherein the interlayer further comprises a NiWCr alloy layer.

17. The recording medium of claim 15, wherein the interlayer further comprises a Cr layer.

18. The recording medium of claim 15, wherein the thickness of the flash layer is in the range of about 5 to about 20 angstroms.

19. The recording medium of claim 15, wherein the crystal structure of the flash layer and the seed layer comprise a hexagonal-close-packed structure that orients a c-axis of the grains of the perpendicular magnetic recording layer perpendicular to the flash layer.

20. The recording medium of claim 15, wherein the flash layer and the seed layer are disposed between the interlayer and the perpendicular magnetic recording layer.

21. A method for fabricating a perpendicular magnetic recording medium, the method comprising:
providing a substrate comprising a rigid support structure for depositing a plurality of layers thereon;
depositing a soft magnetic underlayer;
depositing an exchange break layer, the exchange break layer comprising a seed layer and a flash layer comprising a RuTi alloy; and
depositing a magnetic recording layer having a coercivity and an axis of magnetic anisotropy substantially perpendicular to the surface thereof.

22. The method of claim 21 wherein the concentration of Ti in the RuTi alloy is in the range of about 5 to about 20 atomic percent.

23. The method of claim 21 wherein the concentration of the Ti in the RuTi alloy is about 10 atomic percent.

24. The method of claim 21 wherein the thickness of the flash layer is in the range of about 5 to about 20 angstroms.

25. The method of claim 21, wherein the flash layer and the seed layer are disposed on top of the interlayer.
